(19) United States
(12) Patent Application Publication
(10) Pub. No.: US 2012/0136504 A1
(43) Pub. Date: May 31, 2012

(54) METHOD FOR DRIVING A GROUP OF VEHICLE MEMBERS ON THE BASIS OF DRIVING SITUATIONS, AND CORRESPONDING DEVICE

(75) Inventors: Alessandro De-Rinaldis, Paris (FR); Richard Pothin, Jouars-Ponchartrain (FR); Philippe Saint-Loup, Jouars-Pontchartrain (FR); Nicolas Romani, Paris (FR); Alessandro Monti, La Garenne-Colombes (FR)

(73) Assignee: RENAULT S.A.S., Boulogne-Billancourt (FR)

(21) Appl. No.: 13/140,666

(22) PCT Filed: Nov. 17, 2009
(86) PCT No.: PCT/FR09/52202

§ 371 Date: Oct. 6, 2011

(30) Foreign Application Priority Data
Dec. 18, 2008 (FR) 0858792

(51) Int. Cl. G06F 19/00

(52) U.S. Cl. 701/1

(57) ABSTRACT

A driving method considering driving situations using at least one effective control signal of a member or group of members of an automobile, the method: making an arbitration between different control strategies each corresponding to a driving context, each control strategy being marked with an identifier continuously calculating an optimal control signal corresponding to each of the strategies; continuously transmitting a value representative of the identifier of the selected strategy; detecting if a strategy identifier change has occurred; when a change is detected, generating a time function x(t) increasing from 0 to 1 over a finite time interval starting when the strategy change has been detected; when a strategy identifier change has been detected, transmitting, during at least one time interval following the identifier change, an effective control signal which is the sum of the optimal signal of the control strategy following the last identifier change weighed by the value x(t) and of the optimal signal of the control strategy preceding the last identifier change weighed by the value (1−x(t)).

The present invention is applicable to the field of driving the transmissions of vehicles with four drive wheels.

The transmission systems with which vehicles with four drive wheels are equipped comprise a front axle system and a rear axle system. Each of the front and rear axle systems comprises a rotary axle on each end of which are mounted drive wheels of the vehicle. One of the major problems to be resolved for this type of vehicle is how to correctly distribute the motive torque over the front and rear axle systems of the vehicle when moving. Among the known transmission systems with four drive wheels, viscous coupling makes it possible to ensure a transfer of torque from the axle that is rotating faster to the axle that is rotating less fast, the transfer of the torque being a function of the difference in speed of rotation of the front and rear axles of the vehicle. Another known system consists in using electronic clutches whose operation is either based on the all-or-nothing principle, or determined by various criteria taking into account, for example, the rotation speed differential between the front and rear axles.

There are adaptive systems for optimizing the distribution of torque between the front and rear axles on the basis of driving situations, for example to optimize the take-off of the vehicle and the negotiation of obstacles. The expression “take-off of a vehicle” should be understood to mean the phase between a first and a second state of the vehicle. In the first state, the vehicle is stationary, with no transmission of torque to the wheel. In the second state, the vehicle is in motion with the transmission in a stable state, open or closed.

The patent U.S. Pat. No. 6,115,663 (Yasuda) describes a vehicle with four drive wheels in which the two main drive wheels are the rear wheels (main drive wheels). When the rear wheels start to skid, the traction control system reduces the motive power applied to these rear wheels and then increases the motive power to the front wheels (secondary drive wheels) by virtue of a torque distribution control system. This document does not specify how the signals controlling the transfer torques between rear axle system and front axle system are computed. It mentions a “traction” command which applies the engine torque only to the main drive wheels, and a “distribution” command which distributes the engine torque between the two wheel axle systems, but does not specify the conditions of arbitration and switchover between these commands.

The patent application EP 1275549 (Nissan Motor Co) describes a strategy for distribution of torque between the front and rear axle systems on the basis of different signals such as the wheel speeds, the engine speed, the position of the accelerator pedal. This document proposes a method for optimizing the set point for distribution of the engine torque between the two wheel axle systems. This document does not describe how the new set point is applied each time a new value is computed by the optimization system.

The object of the present invention is to improve the known systems with a method for driving a member or a group of members of a vehicle, which delivers to these members a control signal (current or voltage), satisfying the algorithms which optimize the distribution of forces between these members on the basis of driving situations.

Different driving situations are managed by different computation formulae, also called control strategies.

The object of the invention is to enable the signal to vary according to a continuous function, including at the moment when the optimization algorithms impose a switchover from one control strategy to another control strategy. Discontinuities of the signal during a strategy switchover, when this signal is an electric current or voltage, may in fact generate current or voltage spikes which are damaging to the controlled members.

One of the applications of the invention is the driving of the distribution of the torque from the engine of a vehicle to four drive wheels, between the main drive wheel axle system and the secondary wheel axle system of the vehicle. Other applications can be envisaged, such as the distribution of the torsion torques between two anti-roll bar halves, or the distribution of the forces between four active suspensions positioned at the level of the four wheels of the vehicle.

According to one implementation of a method for driving on the basis of driving situations, by a least one effective control signal, a member or a group of members of an automotive vehicle, arbitration is made between different control strategies each corresponding to a driving context, each control strategy being identified by an identifier. In this method:
an optimum control signal, corresponding to each of the strategies, is continuously computed;
a value representing the identifier of the selected strategy is continuously transmitted;
   if a change of strategy identifier has occurred, it is detected; when a change is detected, a time function x(t) increasing from zero to 1 over a finite time interval beginning at the moment when said change of strategy was detected is generated;
   when a change of strategy identifier has been detected, an effective control signal is transmitted for at least one time interval after this change of identifier, said signal being the sum of the optimum signal of the control strategy after the last change of identifier, weighted by the value x(t), and of the optimum signal of the control strategy preceding the last change of identifier, weighted by the value (1−x(t)).

Advantageously, when a change of identifier is detected, the identifier of the strategy preceding the change is stored in memory.

In a variant implementation, the absolute value of the difference between the effective control signal and the optimum control signal of the strategy currently selected is also computed, and a Boolean switchover indicator is computed, which is positive if this absolute difference value is below a deviation threshold, which is negative otherwise, and which also becomes negative at the moment when a change of identifier is detected.

Advantageously, in this variant implementation, when the computed Boolean switchover indicator is positive, an effective control signal is transmitted which is equal to the optimum signal of the control strategy after the change.

According to a preferred implementation of the same variant of the method, the selection of a new control strategy is prohibited as long as the Boolean switchover indicator is negative.

According to an implementation of the method that can be combined with the preceding ones, the identifier of the selected strategy is computed on the basis of vehicle operation data, notably the speeds of rotation of the wheels, the angle of opening of the intake gas butterfly valve and of the operating point of the engine.

Advantageously, the effective control signal drives a distribution of motive or resistant force between at least one member of the front axle system and at least one member of the rear axle system of the vehicle, or drives a distribution of motive or resistant force between at least one right-hand member and at least one left-hand member associated with the same axle system of the vehicle.

In a preferred application of the method, the effective control signal determines the proportion of torque of the engine which is transmitted to each axle system of a vehicle with four drive wheels.

In another preferred application of the method, at least two effective control signals, each driving a member or a group of members of the vehicle on the basis of control strategies common to these members, are computed as claimed in one of the preceding claims.

According to another aspect, a device for driving a member or a group of members of an automotive vehicle comprises a supervisor capable of arbitrating between different control strategies on the basis of driving situations and capable of transmitting an identifier of the selected control strategy. The device also comprises:
a generator capable of continuously computing an optimum control signal corresponding to each of the control strategies;
a detection block capable of detecting if a change of strategy identifier has occurred;
a storage block capable of storing in memory the value of the strategy identifier preceding the last change of identifier;
a switchover function generator capable of delivering a time function x(t) increasing from zero to 1 over a finite time interval;
a mixing block capable of delivering an effective control signal which is the sum of the optimum signal of the control strategy after the last change of identifier, weighted by the value x(t), and of the optimum signal of the control strategy preceding the last change of identifier, weighted by the value (1−x(t));
a control block, capable of computing the absolute value of the difference between the effective control signal and the optimum control signal of the strategy currently selected, and capable of delivering a Boolean switchover indicator which is positive if this absolute difference value is below a deviation threshold, which is negative otherwise, and which also becomes negative at the moment when a change of identifier is detected.

Other aims, features and advantages of the invention will become apparent from reading the following description, given solely as a nonlimiting example and with reference to the appended drawings in which:

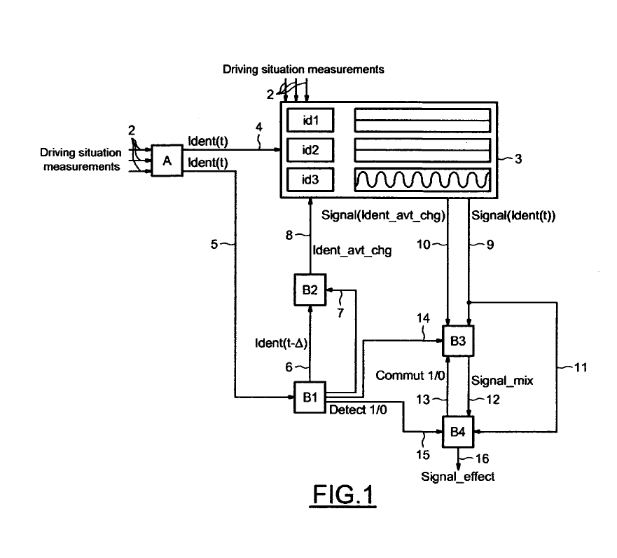

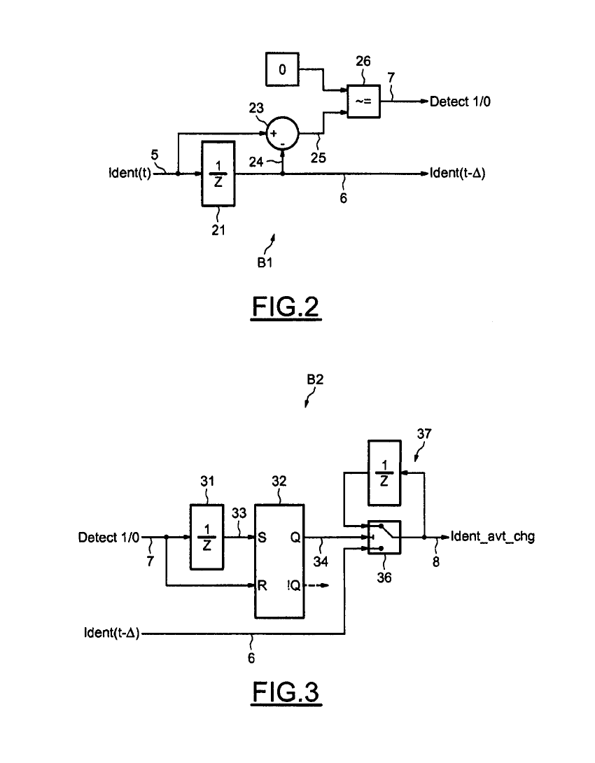

FIG. 1 illustrates the main elements of a driving device according to the invention, FIGS. 2, 3, 4, 5 show exemplary embodiments of a few functional blocks of FIG. 1.

As represented in FIG. 1, a device 1 for driving a group of members of an automotive vehicle receives, via connections 2, measurements making it possible to reconstruct the driving situation of the vehicle, for example the speeds of rotation of the wheels, the aperture angle of the intake gas butterfly valve, the operating point of the engine (represented, for example, by the torque of the engine and the speed of rotation of the engine). These operating parameters are sent to a supervisor block A and to a generator block 3. The supervisor A continuously transmits a strategy identifier “ident(t)” which is a function of the time t, via a connection 4 to the generator 3, and transmits this same strategy identifier, via a connection 5, to a detection block B1. The detection block B1 transmits, via a connection 7, to a storage block B2, a Boolean detection variable “detect”. The detection block B1 transmits, via a connection 6, to the storage block B2, a value “ident(t−Δ)”, which is the value of the preceding strategy identifier corrected by a time delay Δ. The storage block B2 transmits, via a connection 8, to the generator 3, a strategy identifier value “ident_avt_chg”. The generator 3 transmits, via a connection 9, to a mixing block B3, the value of a first signal “signal(ident(t))”. The generator 3 transmits, via a connection 10, to the mixing block B3, the value of a second signal “signal(ident_avt_chg)”. The generator 3 also transmits the value of the first signal “signal(ident(t))”, via a connection 11, to a control block B4. The mixing block B3 transmits, via a connection 12, to the control block B4, the value of a third signal “signal_mix”. The control block B4 transmits, to the mixing block B3, via a connection 13, a Boolean switchover indicator “commut(t)”. The detection block B1 transmits the Boolean detection variable “detect”, via a connection 14, to the mixing block B3, and via a connection 15, to the control block B4. The control block B4 delivers an effective control signal value “signal_effect”, via a connection 16 which brings this signal to the member to be controlled (not represented), which may, for example, be an electrical command for distribution of torque between the front axle system and the rear axle system of a vehicle with four drive wheels, sometimes designated by ETC (electrical torque control).

The supervisor A receives measurements that make it possible to reconstruct the driving situation of the vehicle, originating from various local sensors and computers, for example via a multiplexed network of the CAN bus type, or any other means of communication between computers, represented by the connections 2. On the basis of these operating parameters, for example on the basis of the speeds of rotation of each wheel axle system, of the speed of the engine, of the position of the accelerator pedal, the supervisor selects a control strategy from a discrete number of strategies pre-programmed in the generator 3, for example from a strategy with two drive wheels, a strategy with four drive wheels intended for take-off, a strategy with four drive wheels intended for negotiation. Each of these strategies is identified by a strategy identifier id1, id2, id3 etc. which may for example be an integer. At any instant t, the value of one of these strategy identifiers is transmitted to the generator block 3. The values thus transmitted via the connection 4 constitute the function ident(t).

The generator block 3 has a predefined number of computation algorithms, dedicated to the same member or group of members of the vehicle (for example, a distributor of engine torque between the front wheels and the rear wheels of a vehicle). Each algorithm is associated with a different control strategy of the vehicle (for example, with a motorway running strategy, with a take-off strategy, with a negotiation strategy, with an uphill running strategy, with an abrupt uphill running strategy, etc.). Each control algorithm makes it possible to continuously compute a value of an optimum control signal for the member concerned. This optimum control signal makes it possible to drive said member optimally in relation to the driving situation detected by the arbitration block A. The computation of this optimum control signal may take into account operating parameters of the vehicle supplied to it via the connections 2. These control parameters may be different from the parameters taken into account by the arbitration block A, but may possibly comprise some of the parameters simultaneously taken into account by the arbitration block. Whether or not a control strategy is selected, the generator block 3 computes the control signal corresponding to that strategy. However, only two of the computed signals are transmitted by the generator block 3 to the mixing block B3, via the connections 9 and 10, on the basis of the strategy identifiers received by the generator block 3 via the connections 4 and 8.

Thus, the generator block 3 receives, via the connection 4, the value ident(t) which is the identifier of the currently selected control strategy. In response, the generator block 3 delivers, via the connection 9, the optimum control signal corresponding to this currently selected strategy. The generator block 3 receives, via the connection 8, the value ident_avt_chg which is the identifier of the control strategy which was selected before the current strategy. In response, the generator block 3 delivers, via the connection 10, the optimum control signal corresponding to this previously selected strategy.

FIG. 2 shows an exemplary embodiment of the detection block B1 of FIG. 1. It includes some elements in common with FIG. 1, bearing the same references. The strategy identifier “ident(t)”, arriving via the connection 5, is sent via a first branch of this connection 5 to a delay duplicator 21, which sends, at each instant t, over the connection 6, the delayed value “ident(t−Δ)” of the strategy identifier that it received via the connection 5 at the instant t−Δ. The delay duplicator 21 sends this same delayed value via a connection 24 to a first input of a substractor 23. The strategy identifier “ident(t)” is sent simultaneously via a second branch of the connection 5 to a second input of the subtractor 23. The substractor 23 sends, via a connection 25, to a comparator 26, the value |ident(t)−ident(t−Δ)| corresponding to the absolute value of the difference between the value of the strategy identifier at the instant t and its value at the instant (t−Δ). The comparator 26 performs a test to ascertain whether the value received via the connection 25 is above a detection threshold E close to zero. The comparator 26 delivers, via the connection 7, the Boolean detection variable “detect” which has the value 1 if the value received via the connection 25 is above the detection threshold ε, and which has the value zero if this condition is not satisfied.

FIG. 3 shows an exemplary embodiment of the storage block B2 of FIG. 1. It includes a few elements in common with FIG. 1, bearing the same references. The Boolean detection variable detect(t) arrives via a first branch of the connection 7 at the input R of an RS flip-flop 32. This same Boolean variable detect(t) arrives via a second branch of the connection 7 at a delay duplicator 31, which sends a delayed value detect(t−Δ) of the detection variable via a connection 33 to the input S of the flip-flop 32. The RS flip-flop sends, via a connection 34, a control signal to a switch 36, capable of connecting or disconnecting the connection 6 of a storage loop 37. The storage loop 37 continuously transmits the value that it contains via the connection 8 to the generator 3 (not represented). If a change of strategy identifier is detected at an instant tₒ, the RS flip-flop receives on its inputs R and S, at the instant tₒ, respectively the values detect(tₒ)=1 and detect(tₒ−Δ)=0. The RS flip-flop then receives, on its inputs R and S, at the instant tₒ+Δ, respectively the values detect(t₀+Δ)=0 and detect(tₒ)=1. If the inputs R and S of the flip-flip 32 respectively receive the values 1 and zero, for example at the instant tₒ, the switch 36 connects the connection 6 to the storage loop 37. The storage loop 37 then stores the value of the delayed strategy identifier “ident(t−Δ)”. If the inputs R and S of the flip-flop 32 respectively receive the values zero and 1, for example at the instant tₒ+A, the switch 36 disconnects the connection 6 to the storage loop 37. The storage loop 37 then retains the value that it had previously, for example ident(tₒ−Δ), that is to say, the identifier of the strategy which was selected before the change of stategy detected at the instant tₒ.

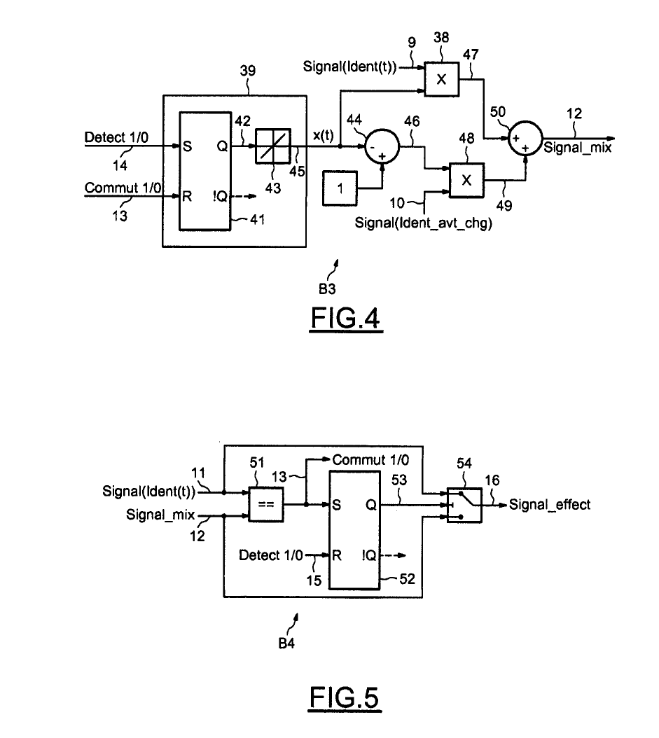

FIG. 4 shows an exemplary embodiment of the mixing block B3 of FIG. 1. It contains a few elements in common with FIG. 1, bearing the same references. The Boolean detection variable detect(t) arrives via the connection 14 at the input S of an RS flip-flop 41. The Boolean switchover indicator commut(t) arrives via the connection 13 at the input R of the RS flip-flop 41. The RS flip-flop 41 transmits, via a connection 42, to a slope limiter 43, the value of its output Q, which has the value 1 when its inputs R and S respectively have the values zero and 1, and which has the value zero when its inputs R and S respectively have the values 1 and zero. The slope limiter 43 transmits, via a first branch of the connection 45, to a multiplier 38, a switchover function value x(t) between zero and 1. The assembly comprising the RS flip-flop 41, the slope limiter 43 and their connection 42 constitute a switchover function generator 39. The slope limiter 43 also transmits, via a second branch of the connection 45, to a subtractor 44, the value x(t) of the switchover function. The subtractor 44 sends, via a connection 46, to a multiplier 48, the one's complement of this switchover function or the value (1−x(t)). The multiplier 48 receives, via the connection 10, the value signal(ident_avt_chg), which is the optimum signal of the control strategy which was selected before the last change of identifier. The multiplier 38 receives, via the connection 9, the value signal(ident(t)), which is the optimum signal of the currently selected control strategy. The multiplier 38 sends, via the connection 47, to an adder 50, the product of the two values that it receives as input via the connections 9 and 45. The multiplier 48 sends, via the connection 49, to the adder 50, the product of the two values values which it receives as input via the connections 10 and 46. The adder 50 transmits, via the connection 12, to the control block B4 (not represented), the sum signal_mix of the values received as input on its connections 47 and 49.

The mixed signal signal_mix therefore has the value:

signal_mix(t)=x(t)*signal(ident(t))+(1−x(t))*signal(ident_avt_chg) (equation 1)

When a change of strategy identifier is detected, the value of the Boolean detection variable changes from zero to 1 during a brief time interval Δt. The RS flip-flop 41 transforms the duly generated pulse function to a level function, that is to say, a function which changes from a constant zero value to a constant value equal to 1 over a very brief transitional time interval. The slope limiter 43 transforms this level function into a switchover function x(t), which increases from the same zero value to the value 1, continuously, over a longer time interval than the preceding transitional interval. This function may, for example, be a piecewise affine function. The switchover function x(t) is then used to compute the mixed signal signal_mix by calculating the average, weighted by x(t) and (1−x(t)), of the optimum control signals delivered via the connections 9 and 10, according to the equation 1.

FIG. 5 shows an exemplary embodiment of the control block B4 of FIG. 1. It contains a few elements in common with FIG. 1, bearing the same references. A first branch of the connection 11 brings the value signal(ident(t)), which is the optimum signal of the currently selected control strategy, to a first input of a comparator 51. A first branch of the connection 12 brings the value of the mixed signal signal_mix(t) to a second input of the comparator 51. A second branch of the connection 11 brings the value signal(ident(t)), which is the optimum signal of the currently selected control strategy, to a first input of a switch 54. A second branch of the connection 12 brings the value of the mixed signal signal_mix(t), to a second input of the switch 54. The comparator 51 delivers, via a first branch of the connection 13, to the mixing block B3 (not represented), the value of the Boolean switchover indicator commut(t). The comparator 51 transmits, via a second branch of the connection 13, this same Boolean switchover indicator to the input S of an RS flip-flop 52. The connection 15 brings the value of the Boolean detection variable detect(t) to the input R of the RS flip-flop 52. The output Q of the RS flip-flop 52 is linked by a connection 53 to a control input of the switch 54. The output of the switch 54 delivers, via the connection 16, the value of the effective control signal signal_effect(t).

The comparator 51 computes the absolute value of the difference between the two values arriving at it via the connections 11 and 12, and compares this absolute value to a deviation threshold ε′ close to zero. If the absolute value of the difference is below the deviation threshold ε′, the comparator assigns the value 1 to the Boolean switchover indicator commut(t). If the absolute value of the difference is above the deviation threshold ε′, the comparator assigns the value 0 to the Boolean switchover indicator commut(t). When a new strategy identifier is detected, the value detect(t) sent to the input R of the flip-flop 52 changes from zero to 1 during a brief time interval Δt. The output signal from the RS flip-flop 52 then becomes equal to 0, and, transmitted via the connection 53, controls the switch 54 to connect the connections 12 and 16. The effective control signal signal_effect is then identical to the mixed signal signal_mix computed by the mixing block B3, and remains identical to it as long as the value arriving at the input S of the flip-flop does not in turn take the value 1. When the difference between the mixed signal computed by the block B3, and the optimum signal of the currently selected control strategy signal(ident(t)) falls below the deviation threshold ε′, the Boolean switchover indicator commut(t) becomes equal to 1. The output signal from the RS flip-flop 52 then becomes equal to 1 and, transmitted via the connection 52, controls the switch 54 to connect the connections 11 and 16. The effective control signal signal_effect then becomes identical to the optimum signal of the currently selected control strategy signal(ident(t)). Since the mixed signal transmitted by the block B3 is no longer used to impose the value of the effective control signal, the input values of the block B3 can then be reset for a new mixed signal computation for switchover between two strategies. This reset of the block B3 is performed by the arrival of a value commut(t) equal to 1 via the connection 13 at the input R of the flip-flop 41. The output Q of the flip-flop 41 then takes the value zero, and imposes, via the slope limiter 43, this same zero value on the switchover function x(t).

It can be noted, in the exemplary embodiment described above, that the mixed signal, used as effective control signal during the switchover between two strategies, is computed on the basis of two signals derived directly from the generator 3. In this configuration, it is advantageous to prohibit a new change of strategy identifier as long as the switchover indicator has not once again become equal to 1. The sudden replacement of the two signals received by the block B3 over its connections 9 and 10 by two other signals associated with two new strategy identifiers is thus avoided. It is possible, however, to envisage variants of the invention in which a new strategy switchover is possible before the switchover indicator has once again become equal to 1, for example by having a number of cascade-connected blocks B3. The mixed signal sign_mix corresponding to the first identifier switchover can then be transmitted over the equivalent of the connection 10 from a block B3 responsible for computing the mixed signal corresponding to the next change of identifier.

It should be noted that the time delay Δ, induced in the signals ident(t) and detect(t) by the delay duplicators 21 and 31, is a time interval that is long enough for a signal variation of this duration to be detectable by means for computing and/or processing the signal constituting the invention. The time delay Δ does, however, remain very short, so as not to penalize the effective switchover time of the control signal from one strategy to another. In practice, this time delay generally corresponds to a sampling period of the computer.

It should also be noted that the reasoning described above concerning the choice of the values 1 or zero assigned to the Boolean switchover indicator (commut) and to the detection variable (detect), should be understood in the functional sense. The positive and negative values of the variables could be designated by pairs of values other than 1/0, for example positive/negative, yes/no, true/false, switched over/stable, completed/current, without changing the nature of the invention. The Boolean values could, while remaining within the context of the invention, have definitions opposite to those of the description, simply by having the cited logic propositions reformulated accordingly.

It should be understood that the signals received or transmitted by the various functional blocks constituting the invention may be any forms of signals capable of conveying a numerical value or a logic value, for example currents, voltages, fiber optic light signals.

Finally, the implementation of the invention in the form of logic blocks or in the form of computation blocks may be done on the basis of electronic components or of physically independent computers arranged as described above. The invention may also be implemented by programming all the logic blocks and the computation blocks described in software form. The corresponding program, and its subroutines, may be installed in one or more computers, incorporated in, or separate from, a central electronic control unit.

The invention makes it possible to drive a vehicle member adaptively, by a control signal, on the basis of a number of control strategies, each appropriate to a driving context, The invention makes it possible to change the vehicle control strategy without engendering discontinuities in the control signal. The transition signal between two control strategies, produced according to the invention, remains a signal that can be adapted to the external forces to which the vehicle is subjected, since it is constructed as an average between two adaptive signals. When a strategy switchover is decided, this switchover can be made rapidly, by a simple average over optimum signals for which the computation has already been made. Furthermore, the invention makes it possible to control the completion of the switchover operation, which gives the possibility, either of avoiding the overlapping of several switchover phases, or of managing these super-posed switchovers. The reliability of the control signal is enhanced, as is driving comfort and safety.

1-10. (canceled)

11. A method for driving based on driving situations, by at least one effective control signal, a member or a group of members of an automotive vehicle, in which an arbitration is made between different control strategies each corresponding to a driving context, each control strategy being identified by an identifier, the method comprising:
continuously computing an optimum control signal, corresponding to each of the strategies;
continuously transmitting a value representing the identifier of the selected strategy;
detecting if a change of strategy identifier has occurred;
when a change of strategy identifier is detected, generating a time function x(t) increasing from zero to 1 over a finite time interval beginning at the moment when the change of strategy was detected;
when a change of strategy identifier has been detected, transmitting an effective control signal for at least one time interval after this change of identifier, the signal being the sum of the optimum signal of the control strategy after the last change of identifier, weighted by value x(t), and of an optimum signal of the control strategy preceding a last change of identifier, weighted by value (1−x(t)).

12. The driving method as claimed in claim 11, in which, when a change of identifier is detected, the identifier of the strategy preceding the change is stored in memory.

13. The driving method as claimed in claim 11, in which the absolute value of the difference between the effective control signal and the optimum control signal of the strategy currently selected is also computed, and a Boolean switchover indicator is computed, which is positive if this absolute difference value is below a deviation threshold, which is negative otherwise, and which also becomes negative at the moment when a change of identifier is detected.

14. The driving method as claimed in claim 13, in which, when the computed Boolean switchover indicator is positive, an effective control signal is transmitted which is equal to the optimum signal of the control strategy after the change.

15. The driving method as claimed in claim 13, in which the selection of a new control strategy is prohibited as long as the Boolean switchover indicator is negative.

16. The driving method as claimed in claim 11, in which the identifier of the selected strategy is computed based on vehicle operation data, including speeds of rotation of the wheels, angle of opening of an intake gas butterfly valve, and an operating point of the engine.

17. The driving method as claimed in claim 11, in which the effective control signal drives a distribution of motive or resistant force between at least one member of a front axle system and at least one member of a rear axle system of the vehicle, or drives a distribution of motive or resistant force between at least one right-hand member and at least one left-hand member associated with the same axle system of the vehicle.

18. The driving method as claimed in claim 11, in which the effective control signal determines proportion of torque of the engine which is transmitted to each axle system of a vehicle with four drive wheels.

19. A driving method in which at least two effective control signals, each driving a member or a group of members of the vehicle on the basis of control strategies common to these members, are computed as claimed in claim 11.

20. A device for driving a member or a group of members of an automotive vehicle, comprising:
a supervisor configured to arbitrate between different control strategies based on driving situations and to transmit an identifier of the selected control strategy;
a generator configured to continuously compute an optimum control signal corresponding to each of the control strategies;
a detection block configured to detect if a change of strategy identifier has occurred;
a storage block configured to store in memory a value of the strategy identifier preceding a last change of identifier;
a switchover function generator configured to deliver a time function x(t) increasing from zero to 1 over a finite time interval;
a mixing block configured to deliver an effective control signal which is the sum of the optimum signal of the control strategy after the last change of identifier, weighted by the value x(t), and of the optimum signal of the control strategy preceding the last change of identifier, weighted by the value (1−x(t)); and
a control block configured to compute the absolute value of the difference between the effective control signal and the optimum control signal of the strategy currently selected, and to deliver a Boolean switchover indicator which is positive if this absolute difference value is below a deviation threshold, which is negative otherwise, and which also becomes negative at the moment when a change of identifier is detected.
